(19) United States
(12) Patent Application Publication
(10) Pub. No.: US 2018/0285828 A1
(43) Pub. Date: Oct. 4, 2018

(54) SCHEDULING A DELIVERY AT A RECIPIENT LOCATION

(71) Applicant: LENOVO (Singapore) PTE. LTD., New Tech Park (SG)

(72) Inventors: John Carl Mese, Cary, NC (US); Nathan J. Peterson, Oxford, NC (US); Russell Speight VanBlon, Raleigh, NC (US); Rod D. Waltermann, Rougemont,, NC (US); Arnold S. Weksler, Raleigh, NC (US)

(21) Appl. No.: 15/478,020

(22) Filed: Apr. 3, 2017

(51) Int. Cl. G06Q 10/10; G06Q 10/08

(52) U.S. Cl. CPC G06Q 10/1095; G06Q 10/0835

(57) ABSTRACT

For scheduling a delivery at a recipient location, a processor determines a delivery time. The processor further determines a recipient location at the delivery time from one or more of calendar entries, messages, an order location, and a device location. In addition, the processor schedules a delivery at the recipient location.

### FIELD

The subject matter disclosed herein relates to scheduling a delivery and more particularly relates to scheduling a delivery at a recipient location.

### BACKGROUND

### Description of the Related Art

Deliveries are regularly scheduled at locations where the intended recipient may be unavailable and/or unexpectedly becomes unavailable.

### BRIEF SUMMARY

An apparatus for scheduling a delivery at a recipient location is disclosed. The apparatus includes an electronic device. The electronic device includes a processor, and a memory that stores code executable by the processor. The processor determines a delivery time. The processor further determines a recipient location at the delivery time from one or more of calendar entries, messages, an order location, and a device location. In addition, the processor schedules a delivery at the recipient location. A method and computer program product also perform the functions of the apparatus.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a delivery scheduling system;

FIG. 2A is a schematic block diagram illustrating one embodiment of recipient data;

FIG. 2B is a schematic block diagram illustrating one embodiment of a vendor policy;

FIG. 2C is a schematic block diagram illustrating one embodiment of a delivery service policy;

FIG. 2D is a schematic block diagram illustrating one embodiment of delivery option data;

FIG. 3 is a schematic block diagram illustrating one embodiment of a delivery option;

FIG. 4 is a schematic block diagram illustrating one embodiment of a computer;

FIG. 5A is a schematic flow chart diagram illustrating one embodiment of a scheduling method;

FIG. 5B is a schematic flow chart diagram illustrating one embodiment of a delivery scheduling method; and

FIG. 5C is a schematic flow chart diagram illustrating one embodiment of a recipient location determination method.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

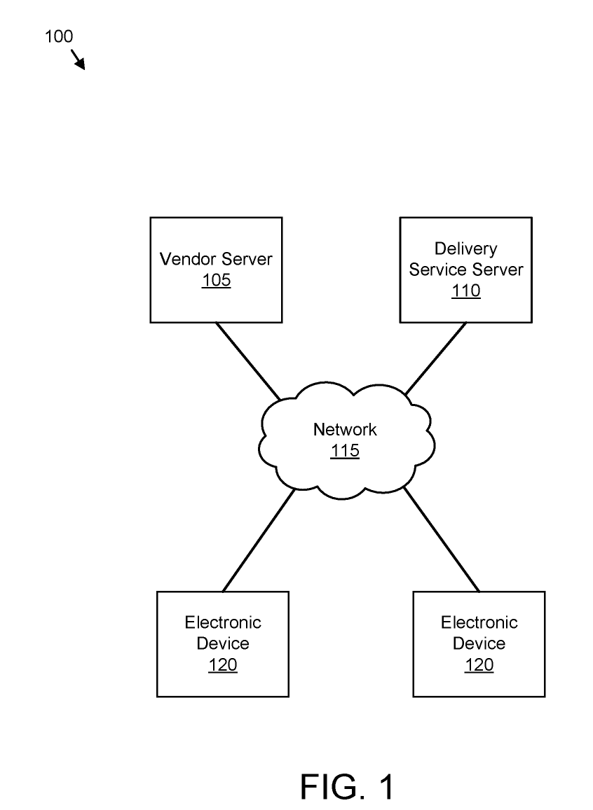

FIG. 1 is a schematic block diagram illustrating one embodiment of a delivery scheduling system 100. The system 100 may schedule a delivery to a recipient. In the depicted embodiment, the system 100 includes a vendor server 105, a delivery service server 110, a network 115, and one or more electronic devices 120. The electronic devices 120 may be employed by one or more of a user, an original recipient, and an alternate recipient.

The network 115 may comprise the Internet, a mobile telephone network, a Wi-Fi network, a wide-area network, a local area network, or combinations thereof. The vendor server 105 may receive an order from an electronic device 120 through the network 115. A recipient and/or user may initiate the order through the electronic device 120. The vendor server 105 may fulfill the order by arranging for a delivery service to provide a product and/or service to the recipient by communicating with the delivery service server 110. The vendor server 105 and/or delivery service server 110 may communicate with the recipient and/or user regarding the delivery through the network to the electronic device 120.

Unfortunately, when scheduling the delivery, the user and/or recipient may have forgotten that the recipient will be unavailable to receive the delivery at a default delivery location. In addition, the user and/or recipient may be unaware that the recipient will be unavailable to receive the delivery at the default delivery location. The embodiments described herein determine a recipient location at a delivery time from one or more of calendar entries, messages, in order location, and an electronic device location. In addition, the embodiments schedule a delivery at the recipient location as will be described hereafter. As a result, the delivery may be reliably made at a recipient location where the recipient is available to receive the delivery.

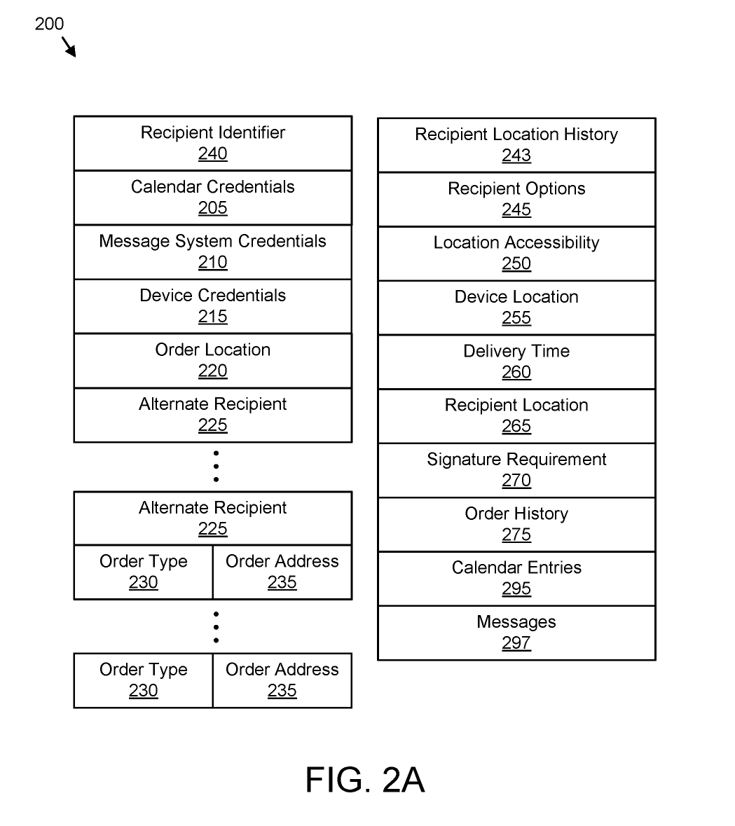

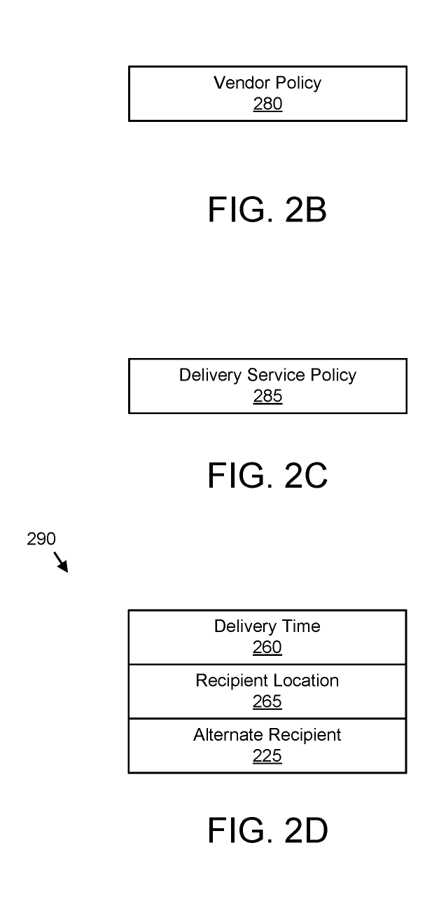

FIG. 2A is a schematic block diagram illustrating one embodiment of recipient data 200. The recipient data 200 maybe organized as a data structure in a memory. The recipient data 200 may be disposed on one or more of the vendor server 105, delivery service server 110, and/or the electronic devices 120. In the depicted embodiment, the recipient data 200 includes a recipient identifier 240, calendar credentials 205, message system credentials 210, device credentials 215, in order location 220, one or more alternate recipients 225, one or more order types 230 and corresponding order addresses 235, a recipient location history 243, recipient options 245, location accessibility 250, a device location 255 a delivery time 260, a recipient location 265, a signature requirement 270, an order history 275, calendar entries 295, and messages 297.

The recipient identifier 240 may uniquely identify the recipient. The recipient identifier 240 may include contact information, personal identifiers, an index to a database, and the like.

The calendar credentials 205 may include credentials for accessing the recipient's calendar. The calendar credentials 205 may be used to access an electronic calendar of the recipient to determine the recipient location 265 at the delivery time 260. In one embodiment, the calendar credentials 205 also be used to retrieve the calendar entries 295 from the electronic calendars for analysis.

The message system credentials 210 may include credentials for accessing the recipient's messaging accounts. The messaging accounts may include email accounts, text messaging accounts, social media accounts, voicemail accounts, and the like. The message system credentials 210 may be used to access the messaging accounts of the recipient to determine the recipient location 265 at the delivery time 260. In one embodiment, the message system credentials 210 are used to retrieve the messages 297 for analysis.

The device credentials 215 may include credentials for accessing a recipient's electronic device 120 and/or for determining the location of the electronic device 120. The device credentials 215 may be used to access the electronic device 120 and determine the device location 255.

The order location 220 may record the location of the recipient when the order was originally placed. The order location 220 may be used to determine the delivery location 265 and the delivery time 260.

The alternate recipients 225 may specify one or more persons that might receive the delivery in place of the original recipient. Each alternate recipient entry 225 may include a name of the alternate recipient, one or more locations of the alternate recipient, contact information for the alternate recipient, and scheduling information for the alternate recipient.

Each order type 230 may describe a type of order. The types of orders may include but are not limited to physical objects, services, categories of physical objects, categories of services, and the like. For example, in order type 230 may be “golf balls” and/or “recreation equipment.” The order address 235 corresponding to the order type 230 may specify one or more locations where deliveries of the order type 230 were made.

The recipient location history 243 may record locations of the recipient over time. In one embodiment, the recipient location history 243 is organized by categories such as work locations, home locations, travel locations, and the like. In addition, the recipient location history 243 may be organized by time intervals such as work hours, after work hours, weekends, holidays, and the like.

The recipient options 245 may specify one or more acceptable recipient locations 265 for receiving a delivery, one or more acceptable delivery times 260 for receiving the delivery at each recipient location 265, delivery preferences, and the like. The recipient options 245 may be consulted to determine if a delivery option is acceptable to the recipient.

The location accessibility 250 may specify a level of accessibility for one or more locations recorded in the recipient data 200. The location accessibility 250 may specify when each location is accessible. In addition, the location accessibility 250 may specify a likelihood that the recipient will be available at the location.

The device location 255 may record the location of the electronic device 120 of the recipient. The delivery time 260 may record a scheduled time for a delivery. The recipient location 265 may record where the delivery is to be made to the recipient.

The signature requirement 270 may specify whether a recipient must sign for the delivery. In addition, the signature requirement 270 may specify whether the recipient must present identification and types of acceptable identification. The order history 275 may record each location from which an order was placed and a corresponding historical recipient location from the recipient location history 243 at which a delivery was received.

FIG. 2B is a schematic block diagram illustrating one embodiment of a vendor policy 280. The vendor policy 280 maybe organized as a data structure in a memory. The vendor policy 280 may be consulted to determine if a delivery option is acceptable to a vendor. In one embodiment, the vendor policy 280 specifies one or more types of acceptable delivery locations, acceptable delivery times for each type of acceptable delivery locations, policies for selecting alternative recipients 225, and the like.

FIG. 2C is a schematic block diagram illustrating one embodiment of a delivery service policy 285. The delivery service policy 285 maybe organized as a data structure in a memory. The delivery service policy 285 may be consulted to determine if a delivery option is acceptable to a delivery service. In one embodiment, the delivery service policy 285 specifies one or more types of acceptable delivery locations, acceptable delivery times for each type of acceptable delivery locations, policies for selecting alternative recipients 225, and the like.

FIG. 2D is a schematic block diagram illustrating one embodiment of delivery option data 290. The delivery option data 290 maybe organized as a data structure in a memory. In the depicted embodiment, the delivery option data 290 includes the delivery time 260 and the recipient location 265. The delivery option data 290 may also include the alternative recipient 225.

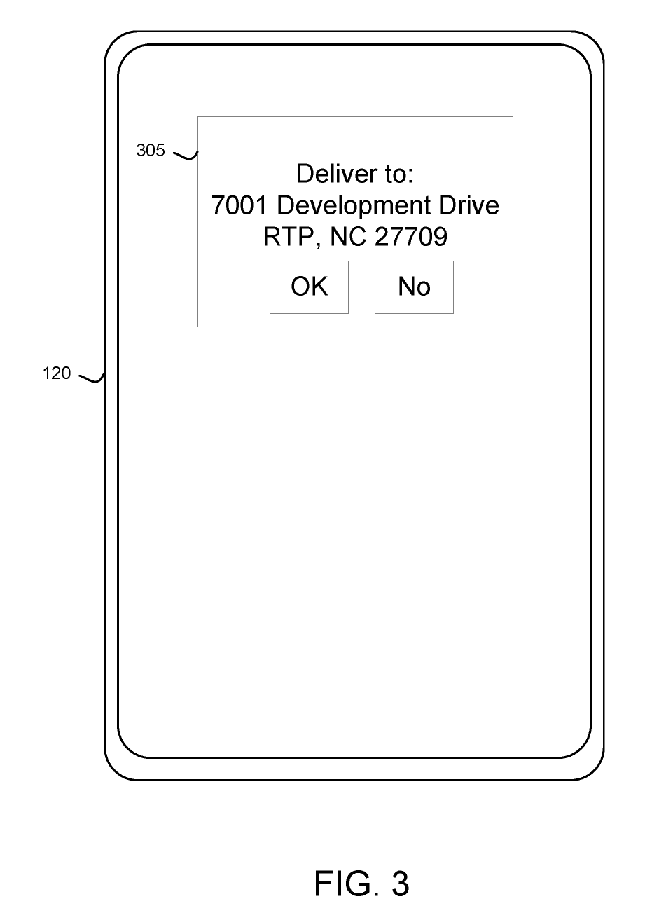

FIG. 3 is a schematic block diagram illustrating one embodiment of a delivery option 305. In the depicted embodiment, the delivery option 305 is presented on the electronic device 120. The delivery option 305 may communicate the delivery option data 290 to a user and/or recipient. In the depicted embodiment, the delivery option 305 communicates a recipient location 265. The recipient and/or user may indicate whether or not to accept a delivery at the recipient location 265. For example, the recipient and/or user may agree to receive the delivery at the recipient location 265 by selecting “OK.”

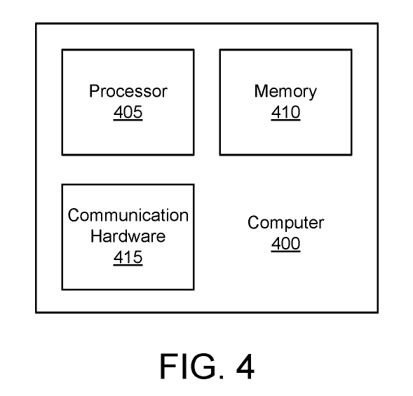

FIG. 4 is a schematic block diagram illustrating one embodiment of a computer 400. The computer 400 may be embodied in one or more of the vendor server 105, the delivery service server 110, and the electronic devices 120. In the depicted embodiment, the computer 400 includes a processor 405, a memory 410, and communication hardware 415. The memory 410 may comprise a semiconductor storage device, hard disk drive, and optical storage device, micromechanical storage device, or combinations thereof. The memory 410 may store code. The processor 405 may execute the code. The communication hardware 415 may communicate with other devices including the network 115.

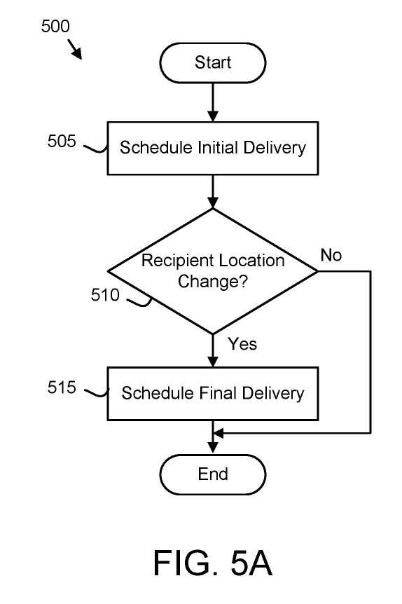

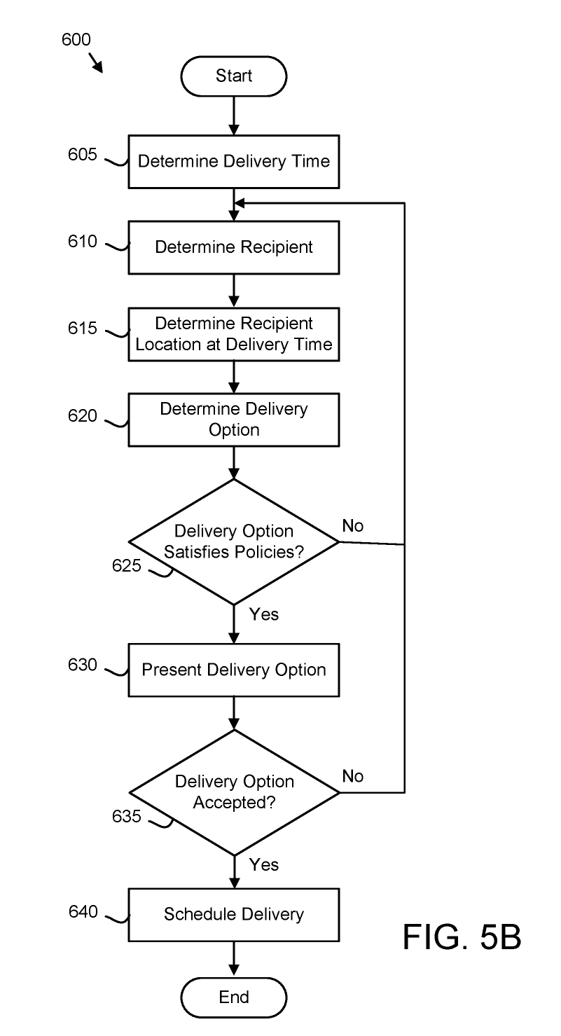

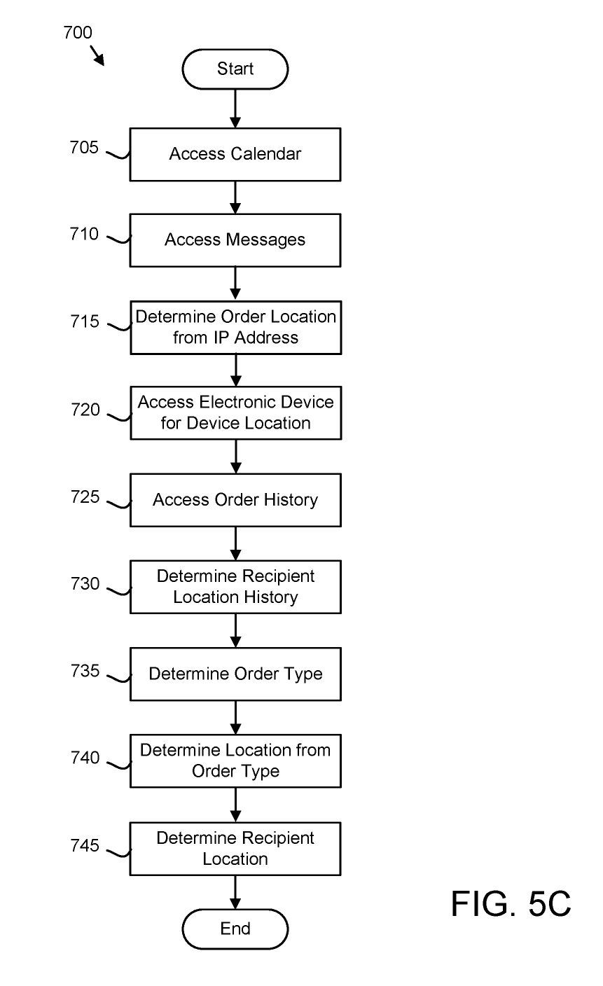

FIG. 5A is a schematic flow chart diagram illustrating one embodiment of a scheduling method 500. The method 500 may determine a delivery time 260 and determine a recipient location 265 at the delivery time 260. The method 500 may be performed by one or more processors 405 of one or more of the vendor server 105, the delivery service server 110, and/or the electronic devices 120.

The method 500 starts, and in one embodiment, the processor 405 schedules 505 an initial delivery. The initial delivery may include a delivery time 260 and a recipient location 265. The scheduling 505 of the initial delivery is described in more detail in FIG. 5B.

The processor 405 may determine 510 if there is a change in the recipient location 265. In addition, the processor 405 may determine 510 if there is a change in the delivery time 260. In one embodiment, the processor 405 determines 510 if there is a change in the recipient location 265 and/or delivery time 260 each time a delivery decision point occurs such as when a package arrives at a transit point. Alternatively, the processor 405 may determine 510 if there is a change in the recipient location 265 and/or delivery time 260 after a specified time interval such as 60-360 minutes.

If there is no change in the recipient location 265 and/or the delivery time 260, the method 500 ends. If the processor 405 determines 510 there is a change in the recipient location 265 and/or the delivery time 260, the processor 405 schedules 515 a final delivery. The scheduling 515 of the final delivery is described in more detail in FIG. 5B.

FIG. 5B is a schematic flow chart diagram illustrating one embodiment of a delivery scheduling method 600. The method 600 may determine the delivery time 260, the recipient location 265, and/or an alternate recipient 225 for a delivery. The delivery time 260, the recipient location 265, and/or the alternate recipient 225 may schedule a delivery for step 505 and/or step 515 of FIG. 5A. The method 600 may be performed by one or more processors 405 of one or more of the vendor server 105, the delivery service server 110, and/or the electronic devices 120.

The method 600 starts, and in one embodiment, the processor 405 determines 605 the delivery time 260 for a delivery. The delivery time 260 may include one or more of a date, a time, and a day of the week. For example, the delivery time 260 may include a specified date and a specified time. The processor 405 may determine 505 the delivery time 260 by determining from the vendor server 105 when a product will be delivered from the vendor to the delivery service. In one embodiment, the processor 405 communicates the time when the product will be delivered from the vendor to the delivery service to the delivery service server 110. The delivery time 260 may be calculated from one or more of an earliest possible delivery time, a most likely delivery time, and a latest possible delivery time provided by the delivery service server 120.

The processor 405 may determine 610 a recipient for the delivery. The recipient may be an original recipient of the delivery and may be identified by the recipient identifier 240. The recipient may be determined 610 in response to one or more of the recipient location 265, a signature requirement 270, and a location accessibility 250. The original recipient may be determined 610 to be the recipient if the recipient location 265 is available for delivery and if the location accessibility 250 indicates the delivery will be successful. Alternatively, the processor 405 may determine 610 the recipient to be an alternate recipient 225 if the recipient location 265 is not available for delivery and/or if the location accessibility 250 indicates the delivery will not be successful. In one embodiment, the recipient is only the alternate recipient 225 if the alternate recipient hundred 25 satisfies the signature requirement 270. The alternate recipient 225 may be determined 610 in response to a selection by the user and/or recipient.

The processor 405 may determine 615 the recipient location 265 at the delivery time 260 from one or more of the calendar entries 295, the messages 297, the order location 220, and the device location 255. The determination 615 of the recipient location 265 is described in more detail in FIG. 5C.

The processor 405 may determine 620 a delivery option 305 for the delivery time 260. The delivery option 305 may be based on the delivery option data 290. The processor 405 may further determine 625 if the delivery option 305 satisfies one or more of the vendor policy 280, the delivery service policy 285, and the recipient options 245. If the delivery option 305 does not satisfy one or more of the vendor policy 280, the delivery service policy 285, and the recipient options 245, the processor 405 may determine 610 a new recipient.

If the delivery option 305 satisfies one or more of the vendor policy 280, the delivery service policy 285, and the recipient options 245, the processor 405 may present 630 the delivery option 305. In one embodiment, the delivery option 305 is presented 630 via the electronic device 120 of the recipient. The processor 405 may further determine 635 if the delivery option 305 is accepted. In FIG. 3, the delivery option 305 is accepted by clicking the “OK” button. If the delivery option 305 is not accepted, the processor 405 may determine 610 a new recipient.

If the delivery option 305 is accepted, the processor 405 may schedule 640 a delivery to the recipient at the delivery time 260 at the recipient location 265 and the method 600 ends. The method 600 may be used to schedule an initial delivery, a final delivery, or combinations thereof.

FIG. 5C is a schematic flow chart diagram illustrating one embodiment of a recipient location determination method 700. The method 700 may determine the recipient location 265. The method 700 may be performed by one or more processors 405 of one or more of the vendor server 105, the delivery service server 110, and/or the electronic devices 120.

The method starts, and in one embodiment, the processor 405 may employ the calendar credentials 205 to access 705 calendar entries 295 of the recipient. The processor 405 may determine the recipient location 265 at the delivery time 260 from the calendar entries 295. In addition, the processor 405 may determine time intervals when the recipient is at the recipient location 265.

In addition, the processor 405 may employ the message system credentials 210 to access 710 message systems of the recipient. The processor 405 may determine 615 the recipient location 265 from the messages 297 retrieved from the message systems. In addition, the processor 405 may determine time intervals when the recipient is at the recipient location 265.

In one embodiment, the processor 405 determines 715 the order location from an Internet protocol (IP) address used to place the order for the delivery. The processor 405 may further access using the device credentials 215 to determine the device location 255. In one embodiment, the device location 255 is determined from a Global Positioning System (GPS) location of the electronic device 120. Alternatively, the device location 255 may be determined from cell tower triangulation, one or more WiFi access points, a service set identifier (SSID), and/or a user entry.

The processor 405 may access 725 the order history 275 for the order location 220. The processor 405 may further determine a recipient location 265 as a delivery location where an order placed from the order location 220 was delivered in the past.

In addition, the processor 405 may determine 730 the recipient location 265 from the recipient location history 243. In one embodiment, the processor 405 determines one or more categories such as a work location and after work hours for the delivery time 260. The processor 405 may further determine the recipient location 265 that matches the categories.

In one embodiment, the processor 405 determines 735 the order type 230 of the order. For example, the order type 230 may be “office supplies.” The processor 405 may further determine 740 the recipient location 265 based on the order type 230. For example, the processor 405 may select the order address 235 “office” corresponding to the order type 230 “office supplies” as the recipient location 265.

The processor 405 may determine 745 the recipient location 265 and the method 700 ends. In one embodiment, the processor determines 745 the recipient location 265 as a function of one or more of the calendar entries 295, the messages 297, the order location 220, the order type 230 and order address 235, the recipient location history 243, the device location 255, and the order history 275 for the delivery time 260. In one embodiment, the recipient location 265 is selected that is a most likely location of the original recipient and/or alternative recipient 225 at the delivery time 260. In one embodiment, the processor 405 identifies one or more recipient locations 265 that the recipient may be at during the delivery time 260. The processor 405 may further determine that the recipient location 265 is a location from a highest priority source. Table 1 shows one embodiment of priorities for each location source.

TABLE 1

| Location | Priority |
|---|---|
| Calendar entries 295 | 1 |
| Messages 297 | 2 |
| Order Location 220 | 3 |
| Device Location 255 | 4 |
| Order History 275 | 5 |
| Order Type 230 | 6 |

In one embodiment, the priorities are dynamically reordered based on which delivery option 305 and recipient location 265 is accepted most often by the recipient and/or user.

The embodiments determine the delivery time 260 for a delivery. In addition, the embodiments determine the recipient location 265 from one or more of calendar entries 295, messages 297, in order location 220, and a device location 255, and schedules the delivery at the recipient location 265. As a result, the delivery is scheduled to reach the recipient in a timely manner.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
an electronic device comprising:
a processor;
a memory that stores code executable by the processor to:
determine a delivery time;
determine a recipient location at the delivery time from one or more of calendar entries, messages, an order location, and a device location; and
schedule a delivery at the recipient location.

2. The apparatus of claim 1, wherein the recipient location is determined for one or more of initial shipment and final delivery.

3. The apparatus of claim 2, wherein the final delivery is scheduled in response to a recipient location change.

4. The apparatus of claim 1, wherein the code is further executable by the processor to:
determine a delivery option for the delivery time;
determine if the delivery option satisfies one or more of a vendor policy, a delivery service policy, and recipient options; and
present the delivery option.

5. The apparatus of claim 1, wherein the code is further executable by the processor to determine a recipient as one of an original recipient and an alternate recipient in response to one or more of the recipient location, a signature requirement, and location accessibility.

6. The apparatus of claim 1, wherein the code is further executable by the processor to:
access the calendar entries using calendar credentials;
access the messages using message system credentials;
determine the order location from an Internet protocol address; and
access an electronic device using device credentials to determine the device location.

7. The apparatus of claim 1, wherein the code is further executable by the processor to:
access an order history; and
determine a recipient location history.

8. The apparatus of claim 7, wherein the code is further executable by the processor to:
determine an order type; and
determine the recipient location based on the order type.

9. A method comprising:
determining, by use of a processor, a delivery time;
determining a recipient location at the delivery time from one or more of calendar entries, messages, an order location, and a device location; and
scheduling a delivery at the recipient location.

10. The method of claim 9, wherein the recipient location is determined for one or more of initial shipment and final delivery.

11. The method of claim 10, wherein the final delivery is scheduled in response to a recipient location change.

12. The method of claim 9, the method further comprising:
determining a delivery option for the delivery time;
determining if the delivery option satisfies one or more of a vendor policy, a delivery service policy, and recipient options; and
presenting the delivery option.

13. The method of claim 9, the method further comprising determining a recipient as one of an original recipient and an alternate recipient in response to one or more of the recipient location, a signature requirement, and location accessibility.

14. The method of claim 9, the method further comprising:
accessing the calendar entries using calendar credentials;
accessing the messages using message system credentials;
determining the order location from an Internet protocol address; and
accessing an electronic device using device credentials to determine the device location.

15. The method of claim 9, the method further comprising:
accessing an order history; and
determining a recipient location history.

16. The method of claim 15, the method further comprising:
determining an order type; and
determining the recipient location based on the order type.

17. A program product comprising a computer readable storage medium that stores code executable by a processor, the executable code comprising code to perform:
determining a delivery time;
determining a recipient location at the delivery time from one or more of calendar entries, messages, an order location, and a device location; and
scheduling a delivery at the recipient location.

18. The program product of claim 17, wherein the recipient location is determined for one or more of initial shipment and final delivery.

19. The program product of claim 18, wherein the final delivery is scheduled in response to a recipient location change.

20. An apparatus comprising:
a server comprising:
a processor;
a memory that stores code executable by the processor to:
determine a delivery time;
determine a recipient location at the delivery time from one or more of calendar entries, messages, an order location, and a device location; and
schedule a delivery at the recipient location.
